(19) United States
(12) Patent Application Publication
(10) Pub. No.: US 2014/0153782 A1
(43) Pub. Date: Jun. 5, 2014

(54) IMAGING SYSTEM AND METHOD FOR DETECTING A WINDING ROAD

(71) Applicant: Gentex Corporation, Zeeland, MI (US)

(72) Inventors: Peter A. Liken, West Olive, MI (US); Christopher B. Case, Caledonia, MI (US)

(73) Assignee: Gentex Corporation, Zeeland, MI (US)

(21) Appl. No.: 14/095,496

(22) Filed: Dec. 3, 2013

Related U.S. Application Data
(60) Provisional application No. 61/733,077, filed on Dec. 4, 2012.

(51) Int. Cl. B60Q 1/00; G06K 9/00

(52) U.S. Cl. CPC B60Q 1/00; G06K 9/00791
USPC 382/104

(57) ABSTRACT

An imaging system and method are provided where the imaging system is configured to image a scene external and forward of a controlled vehicle and to generate image data corresponding to the acquired images. A processor is communicatively connected to the image sensor and is configured to receive and analyze the image data. The processor is further configured to detect whether a road on which the controlled vehicle is traveling is a winding road and generate a signal in response to detection of a winding road.

### CROSS-REFERENCE TO RELATED APPLICATION

This application claims priority to and the benefit under 35 U.S.C. §119(e) of U.S. Provisional Patent Application No. 61/733,077, filed on Dec. 4, 2012, entitled “SYSTEM AND METHOD FOR CONTROLLING VEHICLE FORWARD LIGHTING ON WINDING ROADS,” the entire disclosure of which is hereby incorporated herein by reference.

### FIELD OF THE INVENTION

The present invention generally relates to an imaging system and method capable of controlling exterior lights of a controlled vehicle, and more specifically relates to an imaging system and method that may be used to control exterior lights of a controlled vehicle in response to a detected condition.

### SUMMARY OF THE INVENTION

According to one aspect of the present invention, an imaging system is provided and includes an image sensor configured to image a scene external and forward of a controlled vehicle and to generate image data corresponding to the acquired images. A processor is communicatively connected to the image sensor and is configured to receive and analyze the image data and to detect whether a road on which the controlled vehicle is traveling is a winding road and generate a signal in response to detection of a winding road.

According to another aspect of the present invention, an imaging method is provided and includes providing an image sensor for imaging a scene external and forward of a controlled vehicle and generating image data corresponding to the acquired images. The image data is received and analyzed in a processor communicatively connected to the image sensor. The processor detects whether the road on which the controlled vehicle is traveling is a winding road and generates a signal in response to detection of a winding road.

According to another aspect of the present invention, a non-transitory computer readable medium is provided having stored thereon software instructions executed by a processor. The software instructions include imaging a scene external and forward of a controlled vehicle and generating image data corresponding to the acquired images. The image data is received and analyzed in the processor. The processor detects whether the road on which the controlled vehicle is traveling is a winding road and generates a signal in response to detection of a winding road.

These and other features, advantages, and objects of the present invention will be further understood and appreciated by those skilled in the art by reference to the following specification, claims, and appended drawings.

### BRIEF DESCRIPTION OF THE DRAWINGS

The present invention will be more fully understood from the detailed description and the accompanying drawings, wherein:

FIG. 1 is a block diagram of an imaging system constructed according to one embodiment; and

FIG. 2 is a partial cross section of a rearview assembly incorporating the imaging system in accordance with another embodiment.

### DETAILED DESCRIPTION OF THE PREFERRED EMBODIMENTS

Reference will now be made in detail to the present preferred embodiments, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

The embodiments described herein relate to an imaging system capable of controlling exterior lights of a controlled vehicle in response to image data acquired from an image sensor, which captures images forward of the vehicle. Adaptive Main Beam Control (ADB) and alternate methods of controlling the light beam illumination in front of a motor vehicle maximizes the use of high beams at night by identifying oncoming and preceding vehicles and automatically controlling the high beam lighting pattern. This prevents glare to other vehicles, yet maintains a high beam light distribution to illuminate areas not occupied by other vehicles. Prior systems are known for controlling exterior vehicle lights in response to images captured forward of the vehicle. In these prior systems, a controller would analyze the captured images and determine if any preceding or oncoming vehicles were present in a glare area in front of the vehicle employing the system. This “glare area” was the area in which the exterior lights would cause excessive glare to a driver if the exterior lights were in a high beam state (or some state other than a low beam state). If a vehicle was present in the glare area, the controller would respond by changing the state of the exterior lights so as to not cause glare for the other driver(s). Glare to other drivers can be prevented by moving a blocking mechanism in the high beam headlamps that blocks portions of the light otherwise generated by the headlamps from projecting in selected glare-free regions of the forward scene. Examples of such systems are described in U.S. Pat. Nos. 5,837,994, 5,990,469, 6,008,486, 6,049,171, 6,130,421, 6,130,448, 6,166,698, 6,255,639, 6,379,013, 6,403,942, 6,587,573, 6,593,698, 6,611,610, 6,631,316, 6,653,614, 6,728,393, 6,774,988, 6,861,809, 6,906,467, 6,947,577, 7,321,112, 7,417,221, 7,565,006, 7,567,291, 7,653,215, 7,683,326, 7,881,839, 8,045,760, and 8,120,652, as well as in U.S. patent application Ser. No. 13/432,250 entitled “VEHICULAR IMAGING SYSTEM AND METHOD FOR DETERMINING ROADWAY WIDTH” and filed on Mar. 28, 2012, by Jeremy A. Schut et al., the entire disclosures of which are incorporated herein by reference.

Published United States Patent Application Publication No. US 2013/0261838 A1 entitled “VEHICULAR IMAGING SYSTEM AND METHOD FOR DETERMINING ROADWAY WIDTH” and filed on Mar. 28, 2012, by Jeremy A. Schut et al. discloses an imaging system that improves upon the prior systems by determining a road model based on the roadway width and roadway type (i.e., motorway, two-lane road, multi-lane road, etc.) in order to more accurately discriminate between other vehicles and non-vehicle light sources, reflectors, and road signs and to allow different modes of operation depending upon the type of roadway on which the controlled vehicle is traveling. More specifically, the roadway width may be estimated from various objects detected in the forward scene, including lane markers, reflectors, road signs, and any other objects that may be useful to detect the edges of the road. The roadway type may be determined from the roadway width. Other vehicle parameters such as vehicle speed, yaw, roll, position and vehicle direction may also be used when determining the roadway type and the road model. Then, using the road model, the system may track the positioning (or “world positioning”) relative to the controlled vehicle, the movement, the brightness, the size, the color, and other characteristics of various detected light sources to determine if the light sources appear to be on the roadway. If so, the light sources are more likely to be another vehicle to which the system responds by appropriately controlling the exterior lights.

In prior systems, a problem occurs on winding roads, typical in mountain areas, where the automatic control of the high beam lighting pattern is not able to prevent glare to other vehicles and creates areas without illumination or dark areas that would otherwise be illuminated by the high beams. As a result, a driver navigating a turn can suddenly dazzle an oncoming vehicle and/or lose visibility of the road ahead, especially when the vehicle is travelling at higher speeds. Such a reduction in visibility is generally caused by delays in the movement of the blocking mechanisms in the high beam headlamps or glare-free region of the vehicle.

Accordingly, the imaging system of the present invention is capable of detecting winding roads and may subsequently disable the ADB control. The disabling of the ADB control may result in constant low beam illumination, thereby preventing control of the high beam lighting pattern from suddenly creating the dark areas with high beam illumination and possibly impairing a driver's vision of the road and/or causing glare to other vehicles on the road.

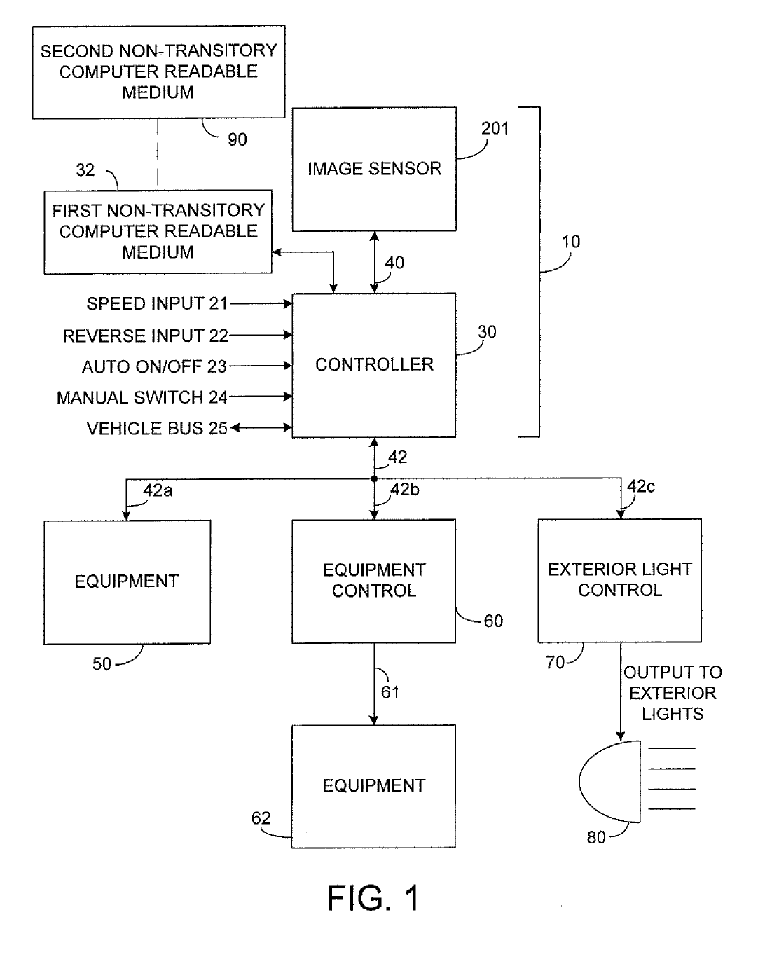

A first embodiment of an imaging system 10 is shown in FIG. 1. Imaging system 10 may control exterior lights 80 and, optionally, other equipment (50, 62) of a controlled vehicle. Imaging system 10 includes an image sensor 201 and a controller 30. Image sensor 201 is configured to image a scene external and forward of the controlled vehicle and to generate image data corresponding to the acquired images. Controller 30 receives and analyzes the image data and generates a signal that may be used to control exterior lights 80 and may generate other signals that may be used to control any additional equipment (50, 62). These signals are generated in response to analysis of the image data.

Controller 30 may be configured to directly connect to the equipment (50) being controlled such that the generated signals directly control the equipment. Alternatively, controller 30 may be configured to connect to an equipment controls (60 and 70), which, in turn, is connected to the equipment being controlled (62 and 80) such that the signals generated by controller 30 only indirectly control the equipment. For example, in the case of the equipment being exterior lights 80, controller 30 may analyze the image data from image sensor 201 so as to generate signals that are more of a recommendation for an exterior light control 70 to use when controlling exterior lights 80. The signals may further include not just a recommendation, but also a code representing a reason for the recommendation so that equipment controls (60 and 70) may determine whether or not to override a recommendation. Further, as described in detail below, the signal may include an indication of the detection of a winding road. Such a winding road detection indication is particularly useful when an equipment controls (60 and 70) that is separate from controller 30 performs the direct control of the equipment.

By providing a winding road detection indication, controller 30 provides additional information to exterior light control 70 and/or equipment control 60 that was not previously made available to such equipment controls. This allows the vehicle manufacturer more flexibility in how they choose to respond to the winding road detection indication. Examples of which are to turn the high beam lighting off or extend the delay following a determination that the winding road is no longer detected so as to delay turning the high beam lighting back on.

The present imaging system improves upon the above-mentioned imaging systems by allowing vehicle manufacturers to respond in a manner of their choosing to the winding road detection indication. This also allows one common system to be used for all manufacturers regardless of whether they wish to change or maintain a particular illumination pattern in response to such an indication. Further, different features of equipment control may be enabled or disabled based upon the detection of a winding road. In addition, different equipment may respond differently to the winding road detection indication.

As shown in FIG. 1, various inputs (such as inputs 21-24) may be provided to controller 30 that may be taken into account in forming a recommendation or direct signal. In some cases, such inputs may instead be provided to equipment controls (60 and 70). For example, input from manual switches may be provided to equipment controls (60 and 70), which may allow equipment controls (60 and 70) to override a recommendation from controller 30. It will be appreciated that various levels of interaction and cooperation between controller 30 and equipment controls (60 and 70) may exist. One reason for separating control functions is to allow image sensor 201 to be located in the best location in the vehicle for obtaining images, which may be a distance from the equipment to be controlled and to allow communication over the vehicle bus 25.

According to one embodiment, the equipment that imaging system 10 controls may include one or more exterior lights 80 and the signal generated by controller 30 may be used to control exterior lights 80. In this embodiment, exterior lights 80 may be controlled directly by controller 30 or by an exterior light control 70, which receives a signal from controller 30. As used herein, the “exterior lights” broadly includes any exterior lighting on the vehicle. Such exterior lights may include headlamps (both low and high beam if separate from one another), tail lights, foul weather lights such as fog lights, brake lights, center-mounted stop lights (CHMSLs), turn signals, back-up lights, etc. The exterior lights 80 may be operated in several different modes including conventional low-beam and high-beam states. They may also be operated as daytime running lights, and additionally as super-bright high beams in those countries where they are permitted.

The exterior light brightness may also be continuously varied between the low, high, and super-high states. Separate lights may be provided for obtaining each of these exterior lighting states or the actual brightness of the exterior lights 80 may be varied to provide these different exterior lighting states. In either case, the “perceived brightness” or illumination pattern of the exterior lights 80 is varied. As used herein, the term “perceived brightness” means the brightness of the exterior lights 80 as perceived by an observer outside the vehicle. Most typically, such observers will be drivers or passengers in a preceding vehicle or in a vehicle traveling along the same street in the opposite direction. Ideally, the exterior lights 80 are controlled such that if an observer is located in a vehicle within a “glare area” relative to the vehicle (i.e., the area in which the observer would perceive the brightness of the exterior lights 80 as causing excessive glare), the beam illumination pattern is varied such that the observer is no longer in the glare area. The perceived brightness and/or glare area of the exterior lights 80 may be varied by changing the illumination output of one or more exterior lights 80, by steering one or more lights to change the aim of one or more of the exterior lights 80, selectively blocking or otherwise activating or deactivating some or all of the exterior lights 80, altering the illumination pattern forward of the vehicle, or a combination of the above.

Image sensor 201 may be any conventional image sensor. Examples of suitable imaging sensors are disclosed in published United States Patent Application Publication Nos. US 2008/0192132 A1 and US 2012/0072080 A1, and in U.S. Provisional Application Nos. 61/500,418 entitled “MEDIAN FILTER” filed on Jun. 23, 2011, by Jon H. Bechtel et al.; 61/544,315 entitled “MEDIAN FILTER” and filed on Oct. 7, 2011, by Jon H. Bechtel et al.; 61/556,864 entitled “HIGH DYNAMIC RANGE CAMERA LOW LIGHT LEVEL FILTERING” filed on Nov. 8, 2011, by Jon H. Bechtel et al., the entire disclosures of which are incorporated herein by reference.

The image sensor 201 (or camera) captures images that may then be displayed and/or analyzed in order to control vehicle equipment in addition to exterior lights. For example, such image sensors have been used for lane departure warning systems, forward collision warning systems, adaptive cruise control systems, pedestrian detection systems, night vision systems, terrain detection systems, parking assist systems, traffic sign recognition systems, and reverse camera display systems. Examples of systems using image sensors for such purposes are disclosed in U.S. Pat. Nos. 5,837,994, 5,990,469, 6,008,486, 6,049,171, 6,130,421, 6,130,448, 6,166,698, 6,379,013, 6,403,942, 6,587,573, 6,611,610, 6,631,316, 6,774,988, 6,861,809, 7,321,112, 7,417,221, 7,565,006, 7,567,291, 7,653,215, 7,683,326, 7,881,839, 8,045,760, and 8,120,652, and in U.S. Provisional Application Nos. 61/512,213 entitled “RAISED LANE MARKER DETECTION SYSTEM AND METHOD THEREOF” and filed on Jul. 27, 2011, by Brock R. Rycenga et al., and 61/512,158 entitled “COLLISION WARNING SYSTEM AND METHOD THEREOF” and filed on Jul. 27, 2011, by Brock R. Rycenga et al., the entire disclosures of which are incorporated herein by reference.

In the example shown in FIG. 1, image sensor 201 may be controlled by controller 30. Communication of image sensor parameters as well as image data occurs over communication bus 40, which may be a bi-directional serial bus, parallel bus, a combination of both, or other suitable means. Controller 30 serves to perform equipment control functions by analyzing images from image sensor 201, determining an equipment (or exterior light) state based upon information detected within those images, and communicating the determined equipment (or exterior light) state to the equipment 50, equipment control 60, or exterior light control 70 through bus 42, which may be the vehicle bus 25, a CAN bus, a LIN bus or any other suitable communication link. Controller 30 may control the image sensor 201 to be activated in several different modes with different exposure times and different readout windows. Controller 30 may be used to both perform the equipment or exterior light control function and control the parameters of the image sensor 201.

Controller 30 can also take advantage of the availability of signals (such as vehicle speed, steering wheel angle, pitch, roll, and yaw) communicated via discreet connections or over the vehicle bus 25 in making decisions regarding the operation of the exterior lights 80. In particular, speed input 21 provides vehicle speed information to the controller 30 from which speed can be a factor in determining the control state for the exterior lights 80 or other equipment. The reverse signal 22 informs controller 30 that the vehicle is in reverse, responsive to which the controller 30 may clear an electrochromic mirror element regardless of signals output from light sensors. Auto ON/OFF switch input 23 is connected to a switch having two states to dictate to controller 30 whether the vehicle exterior lights 80 should be automatically or manually controlled. The auto ON/OFF switch (not shown) connected to the ON/OFF switch input 23 may be incorporated with the headlamp switches that are traditionally mounted on the vehicle dashboard or incorporated into steering wheel column levels. Manual dimmer switch input 24 is connected to a manually actuated switch (not shown) to provide a manual override signal for an exterior light control state. Some or all of the inputs 21, 22, 23, 24 and outputs 42a, 42b, and 42c, as well as any other possible inputs or outputs, such as a steering wheel input, can optionally be provided through vehicle bus 25 shown in FIG. 1. Alternatively, these inputs 21-24 may be provided to equipment control 60 or exterior light control 70.

Controller 30 can control, at least in part, other equipment 50 within the vehicle which is connected to controller 30 via vehicle bus 42. Specifically, the following are some examples of one or more equipment 50 that may be controlled by controller 30: exterior lights 80, a rain sensor, a compass, information displays, windshield wipers, a heater, a defroster, a defogger, an air conditioning system, a telephone system, a navigation system, a security system, a tire pressure monitoring system, a garage door opening transmitter, a remote keyless entry system, a telematics system, a voice recognition system such as a digital signal processor based voice actuation system, a vehicle speed control, interior lights, rearview mirrors, an audio system, an engine control system, and various other switches and other display devices that may be located throughout the vehicle.

In addition, controller 30 may be, at least in part, located within a rearview assembly of a vehicle or located elsewhere within the vehicle. The controller 30 may also use a second controller (or controllers), equipment control 60, which may be located in a rearview assembly or elsewhere in the vehicle in order to control certain kinds of equipment 62. Equipment control 60 can be connected to receive via vehicle bus 42 signals generated by controller 30. Equipment control 60 subsequently communicates and controls equipment 62 via bus 61. For example, equipment control 60 may be a windshield wiper control unit which controls windshield wiper equipment, turning this equipment ON or OFF. Equipment control may also be an electrochromic mirror control unit where controller 30 is programmed to communicate with the electrochromic control unit in order for the electrochromic control unit to change the reflectivity of the electrochromic mirror(s) in response to information obtained from an ambient light sensor, a glare sensor, as well as any other components coupled to the processor. Specifically, equipment control unit 60 in communication with controller 30 may control the following equipment: exterior lights, a rain sensor, a compass, information displays, windshield wipers, a heater, a defroster, a defogger, air conditioning, a telephone system, a navigation system, a security system, a tire pressure monitoring system, a garage door opening transmitter, a remote keyless entry, a telemetry system, a voice recognition system such as a digital signal processor-based voice actuation systems, a vehicle speed, interior lights, rearview mirrors, an audio system, a climate control, an engine control, and various other switches and other display devices that may be located throughout the vehicle.

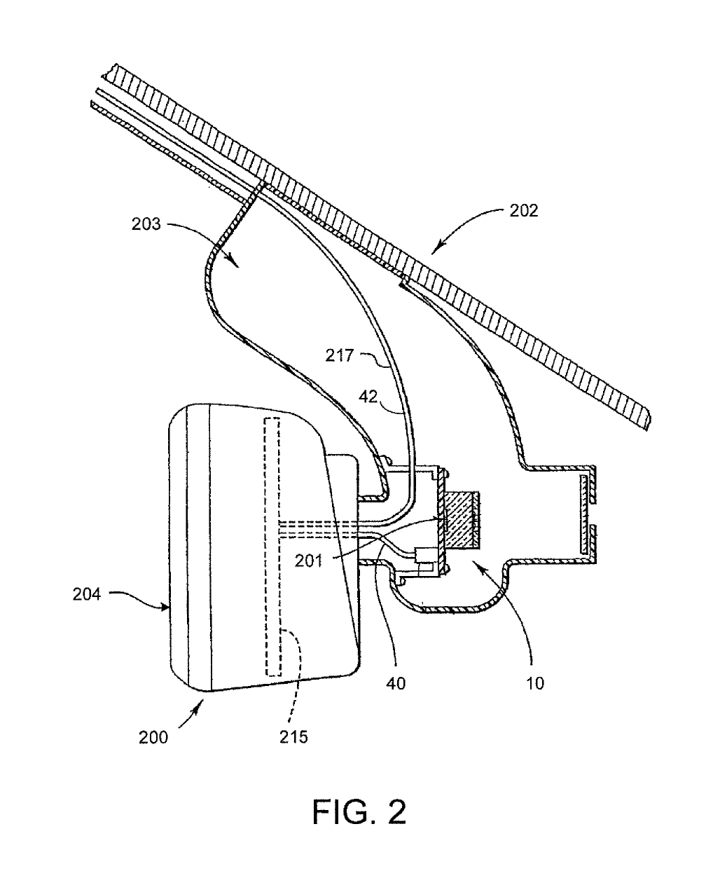

Portions of imaging system 10 can be advantageously integrated into a rearview assembly 200 as illustrated in FIG. 2, wherein image sensor 201 is integrated into a mount 203 of rearview assembly 200. This location provides an unobstructed forward view through a region of the windshield 202 of the vehicle that is typically cleaned by the vehicle's windshield wipers (not shown). Additionally, mounting the image sensor 201 in the rearview assembly 200 permits sharing of circuitry such as the power supply, microcontroller and light sensors.

Referring to FIG. 2, image sensor 201 is mounted within rearview mount 203, which is mounted to vehicle windshield 202. The rearview mount 203 provides an opaque enclosure for the image sensor 201 with the exception of an aperture through which light is received from a forward external scene.

Controller 30 of FIG. 1 may be provided on a main circuit board 215 and mounted in rearview housing 204 as shown in FIG. 2. As discussed above, controller 30 may be connected to image sensor 201 by a bus 40 or other means. The main circuit board 215 may be mounted within rearview housing 204 by conventional means. Power and a communication link 42 with the vehicle electrical system, including the exterior lights 80 (FIG. 1), are provided via a vehicle wiring harness 217 (FIG. 2).

Rearview assembly 200 may include a mirror element or a display that displays a rearward view. The mirror element may be a prismatic element or an electro-optic element, such as an electrochromic element.

Additional details of the manner by which image sensor 201 may be integrated into a rearview mirror assembly 200 are described in U.S. Pat. No. 6,611,610, the entire disclosure of which is incorporated herein by reference. Alternative rearview mirror assembly constructions used to implement exterior light control systems are disclosed in U.S. Pat. No. 6,587,573, the entire disclosure of which is incorporated herein by reference.

The method for controlling exterior lights 80 of a controlled vehicle is described herein as being implemented by controller 30. This method may be a subroutine executed by any processor, and thus this method may be embodied in a non-transitory computer readable medium having stored thereon software instructions that, when executed by a processor, cause the processor to control the equipment of the controlled vehicle, by executing the steps of the method described below. In other words, aspects of the inventive method may be achieved by software stored on a non-transitory computer readable medium or software modifications or updates to existing software residing in a non-transitory computer readable medium. Such software or software updates may be downloaded into a first non-transitory computer readable media 32 of controller 30 (or locally associated with controller 30 or some other processor) typically prior to being installed in a vehicle, from a second non-transitory computer readable media 90 located remote from first non-transitory computer readable media 32. Second non-transitory computer readable media 90 may be in communication with first non-transitory computer readable media 32 by any suitable means, which may at least partially include the Internet or a local or wide area wired or wireless network.

This method may use vehicle operating parameters such as, but not limited to, vehicle yaw, speed, steering wheel angle, and/or a history of the past driving conditions to detect the presence of a winding road and then disable the ADB function or otherwise indicate the presence of a winding road. To detect a winding road (as opposed to a road with one or two turns), the controller 30 detects turns in a road by measuring curve radius and monitors how often turns occur. In this manner, if a predetermined number of turns are detected within a specified period of time, a road may be identified as a winding road. Continued detection of a winding road may result in prolonged disablement of the ADB. However, when the foregoing conditions for a winding road cease to be met, the ADB may then be reactivated, thus signifying that a road has become sufficiently straight.

If controller 30 directly controls exterior lights 80, when a winding road has been detected, controller 30 generates a signal in response thereto that controls exterior lights 80 so as to operate in a low beam state until such time that the vehicle is no longer determined to be driving on a winding road. Conversely, if controller 30 does not directly control exterior lights 80, detection of a winding road may cause controller 30 to generate a signal that (1) indicates the detection of a winding road; (2) indicates that the exterior lights should be operated in a low beam state; (3) indicates a winding road mode of operation, or (4) indicates that the ADB or other automatic dynamic control of the exterior lights should be disabled. The particular indication would behave as more of a recommendation for the exterior light control 70 to use when controlling exterior lights 80 and would depend on the configuration of the exterior light control 70 and the inputs available to control 70, in addition to the needs of a vehicle manufacturer.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. An imaging system, comprising:
an image sensor configured to image a scene external and forward of a controlled vehicle and to generate image data corresponding to the acquired images; and
a processor communicatively connected to the image sensor, the processor configured to receive and analyze the image data and to detect whether a road on which the controlled vehicle is traveling is a winding road and generate a signal in response to detection of a winding road.

2. The imaging system of claim 1, wherein the processor is further configured to receive vehicle operating parameters including at least one of: vehicle speed, steering wheel angle, and yaw, and wherein the controller detects a winding road based upon the vehicle operating parameters.

3. The imaging system of claim 2, wherein the processor detects a winding road by detecting turns in the road and monitoring how often turns occur.

4. The imaging system of claim 3, wherein the processor detects a winding road by determining whether a predetermined number of turns have been detected within a specified period of time.

5. The imaging system of claim 4, wherein the processor detects a turn by measuring a curve radius of the road.

6. The imaging system of claim 1, wherein the signal is used as a recommendation to operate exterior lights of the controlled vehicle in a low beam state until such time that the controlled vehicle is no longer determined to be driving on a winding road.

7. The imaging system of claim 1, wherein the signal indicates one of the following: the detection of a winding road; that exterior lights of the controlled vehicle should be operated in a low beam state; a winding road mode of operation; and that an automatic control of the exterior lights should be disabled; wherein the signal is used as a recommendation for controlling the exterior lights of the controlled vehicle.

8. An imaging method, comprising the steps of:
providing an image sensor for imaging a scene external and forward of a controlled vehicle and generating image data corresponding to the acquired images;
receiving and analyzing the image data in a processor communicatively connected to the image sensor;
detecting with the processor whether the road on which the controlled vehicle is traveling is a winding road; and
generating a signal from the processor in response to detection of a winding road.

9. The method of claim 8, wherein the step of detecting further comprises receiving vehicle operating parameters including at least one of: vehicle speed, steering wheel angle, and yaw, wherein the processor detects a winding road based upon the vehicle operating parameters.

10. The method of claim 9, wherein the step of detecting further comprises detecting turns in the road and monitoring how often turns occur.

11. The method of claim 10, wherein the step of detecting further comprises determining whether a predetermined number of turns have been detected within a specified period of time.

12. The method of claim 11, wherein the processor detects a turn by measuring a curve radius of the road.

13. The method of claim 8, wherein the signal is used as a recommendation to operate exterior lights of the controlled vehicle in a low beam state until such time that the controlled vehicle is no longer determined to be driving on a winding road.

14. The method of claim 8, wherein the signal indicates one of the following: the detection of a winding road; that exterior lights of the controlled vehicle should be operated in a low beam state; a winding road mode of operation; and that an automatic control of the exterior lights should be disabled; wherein the signal is used as a recommendation for controlling the exterior lights of the controlled vehicle.

15. A non-transitory computer readable medium having stored thereon software instructions executed by a processor, the software instructions comprising the steps of:
imaging a scene external and forward of the controlled vehicle and generating image data corresponding to the acquired images;
receiving and analyzing the image data in the processor;
detecting with the processor whether the road on which a controlled vehicle is traveling is a winding road; and
generating a signal from the processor in response to detection of a winding road.

16. The non-transitory computer readable medium of claim 15, wherein the step of detecting further comprises receiving vehicle operating parameters including at least one of:
vehicle speed, steering wheel angle, and yaw, and wherein the controller detects a winding road based upon the vehicle operating parameters.

17. The non-transitory computer readable medium of claim 16, wherein the step of detecting further comprises detecting turns in the road and monitoring how often turns occur.

18. The non-transitory computer readable medium of claim 17, wherein the step of detecting further comprises determining whether a predetermined number of turns have been detected within a specified period of time.

19. The non-transitory computer readable medium of claim 15, wherein the signal is used as a recommendation to operate exterior lights of the controlled vehicle in a low beam state until such time that the controlled vehicle is no longer determined to be driving on a winding road.

20. The non-transitory computer readable medium of claim 15, wherein the signal indicates one of the following: the detection of a winding road; that exterior lights of the controlled vehicle should be operated in a low beam state; a winding road mode of operation; and that an automatic control of the exterior lights should be disabled; wherein the signal is used as a recommendation for controlling the exterior lights of the controlled vehicle.
